(19) United States
(12) Patent Application Publication
(10) Pub. No.: US 2009/0173462 A1
(43) Pub. Date: Jul. 9, 2009

(54) Pivotable screen assembly for screened enclosures

(76) Inventor: James Elfers, Bellview, FL (US)

Correspondence Address: CHARLES E. SMITH, 2321 GRANGE HALL ROAD, DAYTON, OH, 45431, US

(21) Appl. No.: 12/006,694

(22) Filed: Jan. 3, 2008

(51) Int. Cl. E06B 9/24

(52) U.S. Cl. 160/371

(57) ABSTRACT

A wind screen insert for framing members of screened enclosures such as pool cages and the like, the wind screen being adapted to pivot about a vertical or horizontal framing member to which it is hingedly attached. The wind screens which may be of various dimension are mounted within an opening defined by conventional posts/columns, purlins, beams, base and eve rails using at least one double acting spring hinge. The hinge allows the wind screen to pivot up to 90 degrees in either direction relative to its closed or “resting” position when a predetermined amount of force is applied to the wind screen. The hinge also automatically returns the wind screen to its original closed position when the force is diminished below the predetermined amount. The spring tension within the hinges is adjustable to permit screen movement at a desired amount of force applied to the wind screen which will be a function of the screen's surface area and wind speed. The predetermined amount of force needed to open the screen will be less than that which would otherwise cause damage to the screens or surrounding framing. A flange of rubber or other suitable material is disposed around the perimeter of the wind screen framing to create a seal with neighboring framing members and serves as a barrier to insects and flying debris.

### FIELD OF THE INVENTION

The subject invention relates to screened enclosures in general, and more particularly to movable screening panels designed to yield to high wind forces thereby preventing damage to surrounding framing structures to which they are mounted.

### BACKGROUND OF THE INVENTION

Screened enclosures have achieved considerable popularity among residential home owners who enjoy experiencing warm sun and cool breezes of the outdoors without the attendant flies, mosquitoes and other flying insects and debris. A significant number of homes built in warm climates, for instance, will have some form of screened enclosure whether it be a porch, patio or swimming pool area. A majority of such enclosures are constructed of extruded metal framing members including vertical posts/columns, diagonal overhead beams and horizontal cross-bracing purlins and floor-mounted base members. Each such extruded metal framing member includes at least one groove for retaining the screening material which is held in place using a flexible strip of rubber, typically circular or square in cross-section, called a “spline”. Once properly assembled, the screen enclosure creates a physical barrier to unwanted and debris while allowing fresh air to move in and out of the enclosure.

Unfortunately, those same warm climates which are ideal for screened enclosures are also prone to severe weather in the form of high winds and/or hurricanes. When conventionally constructed screened enclosures of the prior art are subjected to extreme wind forces, air is unable to pass through the screening material quickly enough despite its porosity. Air pressure therefore increases on one side of the screened surface which then begins to act much like a sail. Because the framing surrounding the screening material is fixed and rigid the screening material can be caused to stretch and/or tear, or worse yet, the force exerted on the screens can be transferred to the surrounding framing which eventually buckles causing in some instances complete destruction of the enclosure.

Because a majority of the framing components of conventional screened enclosures are constructed of extruded aluminum, a typical solution to the above problem is to increase the thickness and overall dimensions of the extruded framing members, or to modify them with internal reinforcing members, to meet wind load requirements. Although the reinforcement of framing members have been successful in reducing the damage caused by high winds, this method still fails to alleviate stretching or tearing of the screening material itself and the costlier framing members remain susceptible to distortion or collapse.

Another solution is to provide for screening panels which are secured to the surrounding framing in such a way as to break away under high winds. Such a method and apparatus are described in U.S. Pat. No. 5,046,546 issued to Benedyk et al. in 1991. Specifically, Benedyk teaches a screen enclosure apparatus capable of controllably breaking away upon excessive impact of wind pressures on the frame of the apparatus. A frame structure having a channel running along the frame's length serves to releasably or frangibly receive spline material which displaces or fractures at a predetermined resultant pressure thereby releasing the screen sheet, either partially or entirely, from the frame. One shortcoming of this approach is that the screening materials are likely to be lost if released entirely from the framing. Further, the screening material must be reinserted back into the spline grooves, together with new spline material, which is both time-consuming and costly not to mention that the homeowner will not have use of the enclosure in the interim.

In view of the shortcomings and limitations of the above described prior art, it is clear that a need exists for a method and apparatus for constructing screened enclosures that are capable of withstanding forces imparted by high winds.

### SUMMARY OF THE INVENTION

The subject invention rather broadly relates to insect screens adapted to pivot about a vertical or horizontal framing member to which they are hingedly attached. More specifically, wind screens of various dimension are mounted within an opening defined by conventional posts/columns, purlins, beams, base and eve rails using at least one, and preferably but not essentially at least two, double acting spring hinges which a) allow the wind screen to pivot up to 90 degrees in either direction relative to its closed or “resting” position when a predetermined amount of force is applied to the wind screen, and b) automatically return the wind screen to its original closed position when the force is diminished below the predetermined amount. The spring tension within the hinges is adjustable to permit screen movement at a desired amount of force applied to the wind screen which will be a function of the screen's surface area and wind speed. The predetermined amount of force needed to open the screen will be less than that which would otherwise cause damage to the screens or surrounding framing. A flange of rubber or other suitable material is disposed around the perimeter of the wind screen framing to create a seal with neighboring framing members and serves as a barrier to insects and flying debris.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to prevent wind damage to screened enclosures by providing a pivotable screen assembly capable of yielding to wind forces of a predetermined magnitude.

It is also a primary object of the subject invention to provide a pivotable screen assembly for screened enclosures wherein the screen is capable of pivoting at least 90 degrees in either direction relative to its closed or “resting” position.

Another primary object of the subject invention is to provide a pivotable screen assembly for screened enclosures wherein the assembly is adjustable to pivotably yield to a variety of predetermined wind forces.

Yet another object of the subject invention is to provide a pivotable screen assembly having gap sealing means for preventing the passage of insects and flying debris through the gap between the screen assembly and surrounding framing members.

Still another object of the subject invention is to provide an apparatus for the prevention of wind damage to screened enclosures wherein the apparatus is relatively simple in design, comprised of a limited number of components and therefore capable of rapid construction and installation at relatively low costs.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an elevation view of the subject pivotable screen apparatus of the subject invention shown mounted within a typical framing configuration for screened enclosures;

FIG. 2 is an enlarged view of the inset of FIG. 1;

FIG. 3 is a plan view of the subject invention shown mounted to a vertical framing member and illustrating the hinge operation from open (left) to closed (center) to open (right) positions; and

FIG. 4 is an overhead diagram of a typical screened enclosure illustrating how a plurality of the subject pivotable wind screens allow the passage of high force winds there through without causing damage to the framing members.

REFERENCE NUMBER LIST

| | |
|---|---|
| 10 | Pivotable Screen Assembly |
| 12 | Framing |
| 14 | Screen |
| 16 | Hinge |
| 18 | Gap Sealing Means |
| 20 | Top Longitudinal Member |
| 22 | Bottom Longitudinal Member |
| 24 | First Side Wall |
| 26 | Second Side Wall |
| 28 | Spline |
| 30 | Spline Groove |
| 32a | First Axis of Rotation |
| 32b | Second Axis of Rotation |
| 34 | Screen Bearing Side of Frame |
| 36 | Non-Screen Bearing Side of Frame |
| 38 | Leaf of Hinge |
| 40 | Gap |
| 42 | First Directional Arrow |
| 44 | Second Directional Arrow |
| 100 | Post/Column |
| 102 | Purlin |
| 104 | Base Member |
| 106 | Spline Groove |
| 108 | Framing Opening |
| 110 | Dwelling Wall |
| 112 | First Side Wall of Enclosure |
| 114 | Second Side Wall of Enclosure |
| 116 | Transverse Wall of Enclosure |
| 118 | Pool |
| 120 | Interior of Enclosure |
| 122 | Exterior of Enclosure |

### DETAILED DESCRIPTION OF THE PREFERRED EMBODIMENT

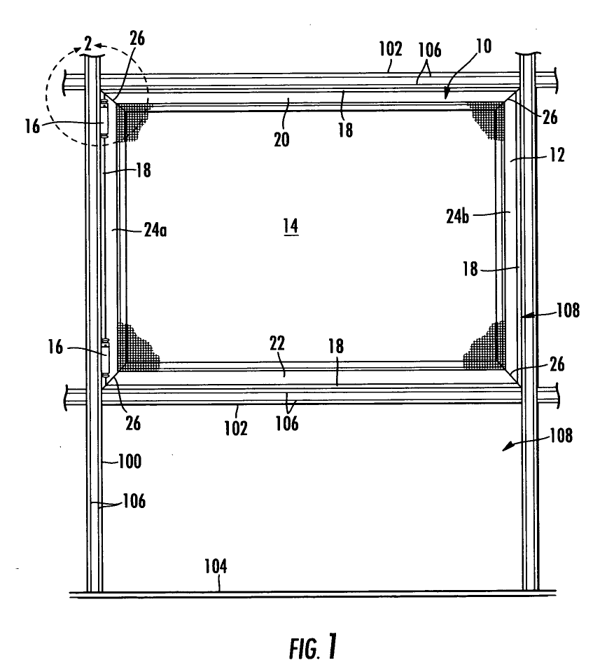

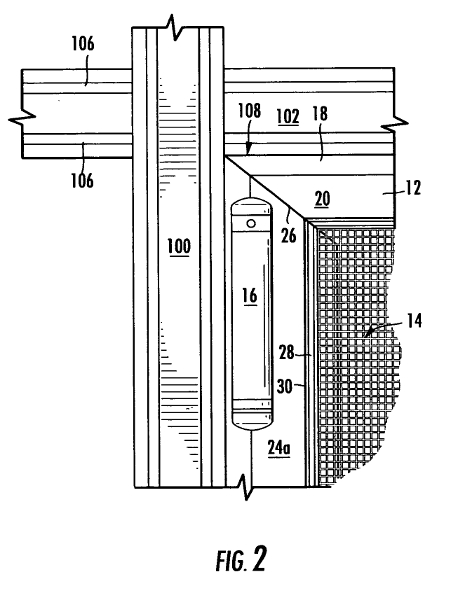

In order that the construction and benefits of the subject invention may be fully appreciated it is first necessary to understand the environment within which it is installed, namely a framed enclosure. Accordingly, reference is first made to FIGS. 1 and 2 in which there is illustrated a typical configuration of framing members which are most commonly of the extruded aluminum type. More specifically, the various framing members used to create a “pool cage” or other similar screened enclosure include: 1) vertically oriented posts 100 (sometimes called “columns”) which are the primary support means for side walls, 2) diagonally oriented beams (not shown) which are the primary support means for the roof structure, 3) horizontally oriented purlins 102 disposed between posts and between beams to impart stability and lateral support, and 4) base members 104 which are used to anchor screening material to the floor about the enclosure's perimeter. In screened enclosures of the prior art, once the frame of the enclosure is erected, the screening material is mounted by inserting its edges within spline grooves 106 integrally formed in each framing member and securing it in place using flexible strips of rubber or vinyl (“splines”) which are pressed into the grooves over the screening fabric. It may be noted at the outset that not all framing openings 108 need by occupied by the subject pivotable screen assemblies to protect a screened enclosure from damage due to high winds. The goal is to reduce the surface area upon which wind forces can work by creating temporary openings for wind to pass, including wind which would otherwise act on screens in close proximity to the openings. As long as there exists sufficient openings for wind to pass through the enclosure, force typically transferred to the surrounding framing members are diminished thereby preventing framing failure.

With continued reference to FIGS. 1 and 2, a preferred embodiment of the subject pivotable screen assembly of the present invention, identified generally by reference numeral 10, is illustrated mounted within a rectangular opening 108 defined by a pair of parallel vertical columns 100, and a pair of parallel horizontal purlins 102 there between. Pivotable screen assembly 10 is comprised generally of four primary components: 1) a rectangular frame 12, 2) a screen 14 retained within frame 12, 3) at least one double action spring hinge 16, and 4) gap sealing means 18 fixedly attached to frame 12 and sized to come into frictional and sealing engagement with the surrounding framing members of an enclosure.

More specifically, frame 12 is constructed of top and bottom longitudinal members 20 and 22, respectively, disposed between first side member 24a and second side member 24b, all fabricated from extruded aluminum or other suitable material commonly used to construct conventional window screens, and all preferably but not essentially connected to one another via mitered joints 26. While frame 12 will most commonly have a rectangular (four-sided) configuration it is contemplated that other geometric shapes having three or greater than four sides are also within in the scope of the subject invention.

Screen 14 is of metal wire, fiberglass, or other synthetic fiber mesh construction, stretched in frame 12. As may be appreciated, its primary purpose is to keep insects, leaves, birds, and animals from entering a building or a screened structure such as a porch, while permitting fresh air-flow. Screen 14 is typically cut larger then frame 12, laid over it and a rubber cord or “spline” 28 (FIG. 2) is pressed over the screen into spline grooves 30 of frame 12. The most common materials used for insect screening material are aluminum and fiberglass. Aluminum is generally available in natural aluminum or in an applied charcoal color. The charcoal is much less visible and should be preferred where the view through the screens is important. Fiberglass is available in light gray as well as charcoal colors, the charcoal again offering better viewing and appearance. Fiberglass is less expensive, and has the advantage of not “denting” when hit or pushed. However, the fiberglass mesh is somewhat more opaque than aluminum mesh, which darkens the external appearance of the window and reduces the amount of light transmitted from outside. For applications requiring greater strength, such as screened doors, nylon, and polyester screening is also available. A new screening material that claims to be virtually transparent is currently manufactured by W. L. Gore & Associates, marketed by Pella Windows under the name “Vivid View”®. The premier material for insect screening is bronze. Bronze will give much longer service than either aluminum or fiberglass. When first installed, it has an unattractive gold color which weathers to an unobtrusive dark charcoal within a year or less. Bronze is somewhat more resistant to denting than aluminum. The very high cost of bronze screening explains why it is not more commonly used. Less common screen fabrics include copper, brass, stainless steel and galvanized steel. In addition to insect screening, denser screen types that also reduce sunlight and heat gain are available.

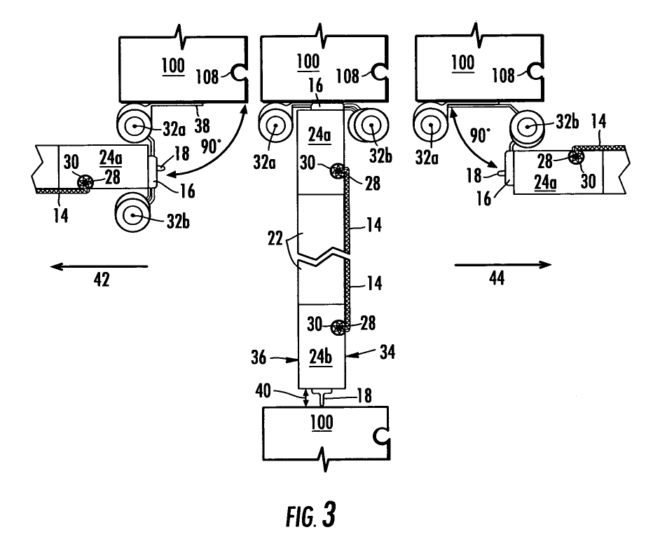

As best may be observed upon reference to FIG. 3, hinge 16 is again of the double action spring type meaning that it permits frame 12 to open up to at least 90 degrees in either direction relative to its closed or resting position (FIG. 3—Center) where tension on its internal springs is measured at zero. The spring(s) within hinge 16 may be adjusted to selectively increase or decrease tension, requiring greater or lesser amounts of force exerted upon frame 12 and screen 14 to cause their rotation about one of two axes of rotation 32a and 32b, depending on the direction of the wind.

FIG. 3—Center is a plan view of the subject pivotable screen assembly 10 installed between two columns 100. For ease of understanding, top and bottom purlins 104 are not shown and top longitudinal member 20 has also been removed to better illustrate retention of screen 14 within spline grooves 30 using splines 28, each located on the screen bearing side 34 of frame 12. Note that screen bearing side 34 will typically face the outside of the screened enclosure, while non-screen bearing side 36 faces the interior of the enclosure.

A first hinge 16 is mounted to first side member 24a using conventional fastening means and is located preferably in close proximity to the top of frame 12 (FIG. 2). Similarly, a second hinge is mounted to first side member 24a in close proximity to the bottom of frame 12. Additional hinges may be employed between the first and second hinges when longer vertical side members are involved to impart greater support and to increase aggregate spring tension as may be needed to bias against wind forces acting on a greater screen surface area. As wind speed and/or screen surface area increase, greater aggregate spring tension will be required to hold a screen closed until the predetermined amount of force is exerted upon it causing the assembly to open. As should be obvious to those skilled in the art, a leaf 38 of each hinge 16 is then mounted to support column 100 to pivotally secure frame 12 within an opening 108.

Properly mounted, frame 12 will be centered within opening 108 leaving a gap 40 of approximately ⅜″ to ⅝″ between frame 12 and surrounding framing members. Gap sealing means 18, in the form of a flanged rubber strip is fixedly attached to all four sides of frame 12 using construction adhesive or other suitable attachment means. Gap sealing means 18 will be attached around the entire perimeter of frame 12 except in those areas occupied by hinges 16. Once mounted, gap sealing means may be trimmed as necessary to account for framing that may be out of square so as to come into uniform frictional and sealing engagement with surrounding framing members, thereby creating a barrier to insects and flying debris which might otherwise pass through gap 40. It should be appreciated that pivotable screen assembly 10 may alternately be mounted along a horizontal axis, preferably below a horizontal support member.

Referring to FIG. 3—Left, a force applied generally along directional arrow 42 will act upon frame 12 and screen 14 causing the former to pivot about axis of rotation 32a up to at least 90 degrees of rotation. Similarly, referring to FIG. 3—Right, a force applied generally along directional arrow 44 will act upon frame 12 and screen 14 causing the former to pivot about axis of rotation 32b up to at least 90 degrees of rotation.

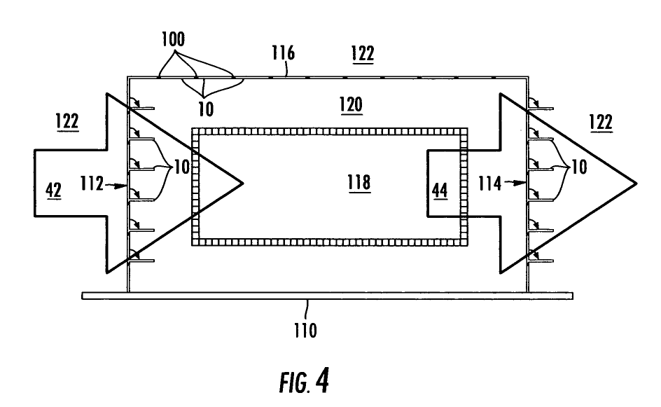

With reference now being made to FIG. 4, a plurality of the subject pivotable screen assembly 10 are shown installed between columns 100 in a typical screened enclosure defined by a dwelling wall 110, enclosure side walls 112 and 114, and transverse wall 116. The screened enclosure therefore creates an open-air, pest-free environment often constructed for the enjoyment of a swimming pool 118 and other outdoor recreational furniture and equipment within its interior 120.

In operation, the spring tension of each hinge 16 of each pivotable screen assembly 10 is adjusted to move when a wind force of a predetermined magnitude is exerted against it. In most instances, this force will be less than that which would cause displacement of screen 14 from framing 12 and preferably less than that which would cause stretching or other disfiguring of screen 14. Typically, this will be a force of less than 5 psf when exerted on a 7′ wide by 8′ high 14/10 fiberglass screen with PVC drip coating having open areas not less than 60 percent and in which the screen sheet is secured within a 0.297″ wide×0.150″ spline groove of a 2″×2″×0.37″ aluminum frame. When wind forces (denoted by first directional arrow 42) of a predetermined magnitude act upon the frames 12 and screens 14 of pivotable screen assemblies 10 located on side wall 112, they are caused to rotate about hinges 16 toward the interior 120 of the enclosure thereby reducing pressure buildup which might otherwise cause damage to the screens and framing members from which they depend, as well as to screening material which has been conventionally mounted to the framing. As moving air enters the interior 120 of the enclosure, pressure once again increases until screen assemblies 10 located on side wall 114 and/or 116 yield to the predetermined amount of force (denoted by second directional arrow 44) and pivot outward to the exterior 122 of the screened enclosure. High wind pressure is thereby allowed to pass through the openings 108 previously occupied by the subject pivotable screen assemblies thereby diminishing or precluding damage to the screened enclosure.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by letters patent of the United States is as follows:

1. A pivotable screen assembly for mounting within a framed opening defined by at least three sides, the pivotable screen assembly comprising:
a. a frame;
b. a screen retained within said frame;
c. at least one double action spring hinge operably disposed between said frame and one of the at least three sides of the framed opening; and
d. gap sealing means fixedly attached to said frame and sized to come into frictional and sealing engagement with the at least three sides of the framed opening.

2. A pivotable screen assembly for mounting within a framed opening defined by at least three sides, the pivotable screen assembly comprising:
a. a frame having an outer perimeter;
b. a screen retained within said frame such that a gap of approximately ⅜″ to ⅝″ exists between said outer perimeter of said frame and the at least three sides of the framed opening;
c. at least one double action spring hinge operably disposed between said frame and one of the at least three sides of the framed opening; and
d. gap sealing means fixedly attached to said outer perimeter of said frame and sized to occupy said gap and to come into frictional and sealing engagement with the at least three sides of the framed opening.

3. The pivotable screen assembly of claim 1 wherein said at least one double action spring hinge includes a spring capable of manual adjustment to different tensions.

4. The pivotable screen assembly of claim 2 wherein said at least one double action spring hinge includes a spring capable of manual adjustment to different tensions.

5. The pivotable screen assembly of claim 1 wherein said gap sealing means is comprised of a rubber flange.

6. The pivotable screen assembly of claim 2 wherein said gap sealing means is comprised of a rubber flange.

7. The pivotable screen assembly of claim 3 wherein said gap sealing means is comprised of a rubber flange.

8. The pivotable screen assembly of claim 4 wherein said gap sealing means is comprised of a rubber flange.
